(19) United States
(12) Patent Application Publication
(10) Pub. No.: US 2010/0073376 A1
(43) Pub. Date: Mar. 25, 2010

(54) ELECTRONIC IMAGING DEVICE AND METHOD OF ELECTRONICALLY RENDERING A WAVEFRONT

(75) Inventor: Peter Christiaan Schmale, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,590

(22) PCT Filed: Nov. 16, 2007
(86) PCT No.: PCT/IB07/54680

§ 371 Date: Apr. 7, 2009

Related U.S. Application Data
(60) Provisional application No. 60/867,850, filed on Nov. 30, 2006.

(51) Int. Cl. G06T 11/20; G09G 5/00

(52) U.S. Cl. 345/440; 345/8; 345/94

(57) ABSTRACT

An electronic wavefront device (10) comprises a controller (32) configured to provide a wavefront rendering signal and at least one wavefront rendering device (12, 14) coupled to said controller. The at least one wavefront rendering device is configured to produce a holographic wavefront on a respective plane of the at least one wavefront rendering device in response to the wavefront rendering signal. The holographic wavefront on the respective plane is configured to reproduce an incoming wavefront that would otherwise be incident on the respective plane if an object or scene being reproduced from the incoming wavefront were actually in front of the at least one wavefront rendering element.

The present embodiments relate generally to image reproduction systems and more particularly, to an electronic wavefront device and method of electronically rendering a wavefront.

Today's active lifestyle calls for mobile entertainment solutions. One well-known example is the iPod™ mobile music player from Apple Computer Incorporated. However, true mobility has not yet been achieved for video based entertainment due to the lack of a suitable and comfortable mobile, wearable display. Although various forms of wearable displays have been put on the market, they have had only very limited success. Examples include the myvu™ personal media viewer from The MicroOptical Corporation of Westwood, Mass. and the DV920 Digital Video Eyewear from the Icuiti Corporation of Rochester, N.Y.

Present commercially available wearable displays are disadvantageously too big and heavy. Furthermore, the commercially available wearable displays look too conspicuous for casual use in public. This is fundamentally caused by the bulk and size of the optical system of the wearable displays that is required to project a real image from the wearable display (e.g. a small LCD display) into the eye, such that the eye can focus on it. Another disadvantage of currently known wearable display systems is that they impair normal vision of the user's surrounding, even if the display functionality is temporarily not used.

Current research on holographic displays focuses on the use case of a stationary display unit that is viewed by an observer that can move. This is in line with a main objective of reproducing a 3D image, which also makes it desirable to have a wide range of possible viewing angles. Unfortunately, the wider the required viewing angle, the smaller the pixel size of the SLM must be, thereby calling for pixel sizes below 1 μm, which is far below the current state of the art of 10 μm.

Accordingly, an improved method and system for overcoming the problems in the art is desired.

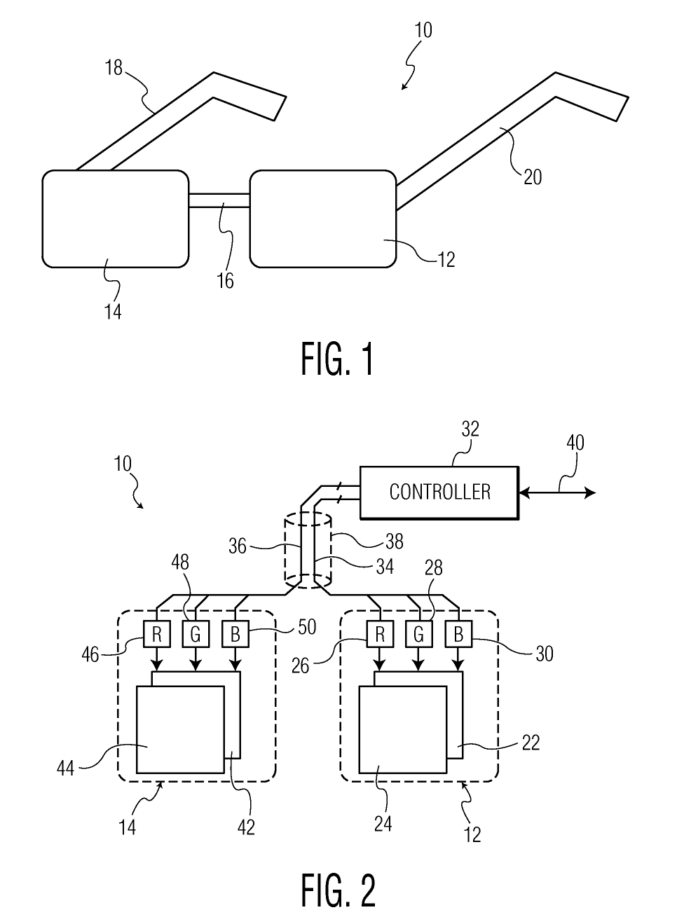

FIG. 1 is a plan diagram view of electronic wavefront rendering eyeglasses according to one embodiment of the present disclosure;

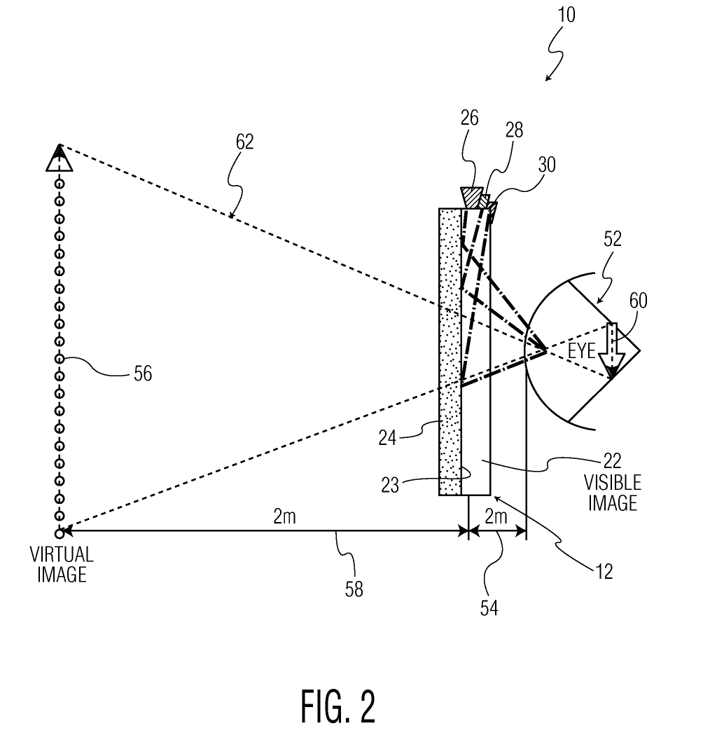

FIG. 2 is a block diagram view of the electronic wavefront device according to an embodiment of the present disclosure;

FIG. 3 is a cross-sectional diagram view of an electronic wavefront rendering element of the electronic wavefront device according to an embodiment of the present disclosure;

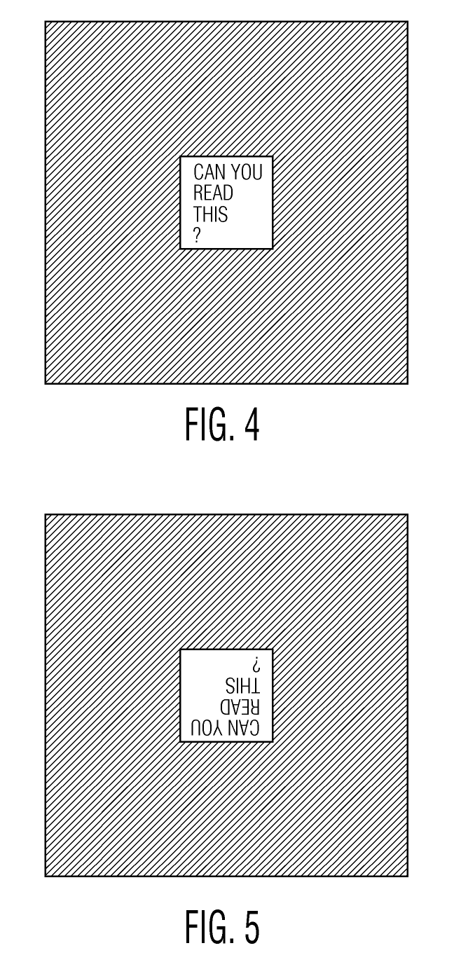

FIG. 4 is a simulated pictorial view of an image of an object located at a predetermined distance in front of the plane of a wavefront rendering element of the electronic wavefront device according to an embodiment of the present disclosure;

FIG. 5 is a simulated pictorial view of an image of the object of FIG. 4 located at a second distance behind the plane of the wavefront rendering element of the electronic wavefront device;

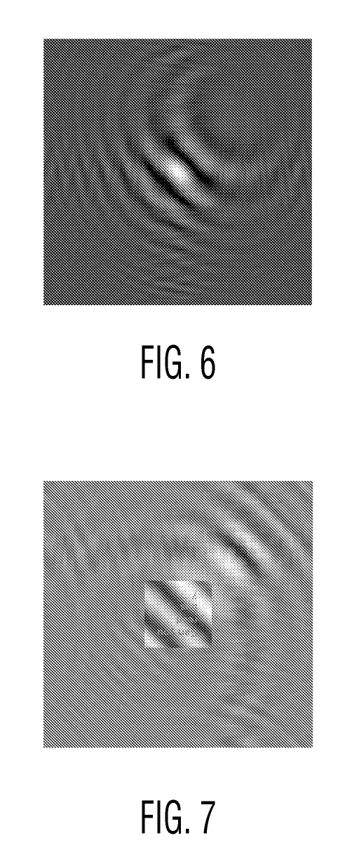

FIG. 6 is a simulated view of a resulting hologram of the image of the object of FIG. 4 located at a plane of the eye lens of an observer, wherein the distance between the hologram and the eye is zero; and

FIG. 7 is a simulated view of a hologram of the image of the object of FIG. 4 as observed at a second distance behind the plane of the wavefront rendering element of the electronic wavefront device.

In the figures, like reference numerals refer to like elements. In addition, it is to be noted that the figures may not be drawn to scale.

As discussed herein, electronic wavefront rendering viewing glasses are configured to display a waveform matrix in which wavefronts of visible light are shaped close to the eye to produce an image. The wavefront reproduces, with sufficient accuracy, the incoming wavefront, that would be incident on a plane of the glasses if the object or scene reproduced were really in front of the viewer. Displaying an image in this way will permit: (1) controlling the transmission of light, to give functionality of sunglasses, (2) displaying a static but adjustable holographic pattern that will make the device function as a Holographic Optical Element, giving functionality of highly flexible ophthalmic glasses, (3) displaying 2D video or a computer screen that appears to be at a convenient distance from the viewer (e.g. with a dynamically computed hologram rendered) and (4) displaying of 3D pictures or 3D video. SLM's (Spatial Light Modulator), for example, may be used to reproduce the wavefront image. The glasses can have the same approximate size, shape, place and look as regular ophthalmic glasses or sunglasses.

Further as discussed herein, in one embodiment, electronic wavefront rendering viewing glasses use a pair of Spatial Light Modulators (SLM's) in place of normal lenses in a pair of eyeglasses. The use of SLM will permit: (i) controlling the transmission of light, to give functionality of sunglasses; (ii) displaying a static but adjustable holographic pattern that will make the SLM function as a Holographic Optical Element, giving functionality of highly flexible ophthalmic glasses; (iii) displaying of 2D video or computer screen that appears to be at a convenient distance from the viewer. This can be done with a dynamically computed hologram that is rendered with the SLM; and (iv) displaying of 3D pictures or 3D video.

FIG. 1 is a plan diagram view of electronic wavefront rendering eyeglasses 10 according to one embodiment of the present disclosure. Electronic wavefront rendering eyeglasses 10 comprise at least one wavefront rendering device. As illustrated, the at least one wavefront rendering device of eyeglasses 10 includes a first wavefront rendering element 12 and a second wavefront rendering element 14. The first and second wavefront rendering elements (12,14) are embodied in an eyeglasses frame which includes a bridge portion 16, and temple portions 18 and 20. In one embodiment, eyeglasses 10 include wearable eyeglasses that are adapted for being positioned, in response to being worn by an user, with the wavefront rendering elements (12,14) located in front of a wearer's eyes, respectively. In particular, the two wavefront rendering elements are coupled to the frame in a manner adapted to position the wavefront plane of each of the two wavefront rendering elements at the second distance in front of an observer's eyes. In addition to an eyeglasses frame, in an alternate embodiment, the frame may comprise one selected from the group consisting of a hand-held non-wearable frame, a wearable frame, and a helmet.

FIG. 2 is a block diagram view of the electronic wavefront device 10 according to an embodiment of the present disclosure. Similarly, electronic wavefront device 10 includes first wavefront rendering element 12 and second wavefront rendering element 14. Wavefront rendering element 12 includes a transparent element portion 22 and a hologram generating portion 24. In one embodiment, the transparent portion 22 comprises a form of holographic glass which can collectively include any suitable kind of glass or construction of glass used to construct the holographic rendering element. The hologram generating portion 24 comprises red, green, and blue lasers (26, 28, 30, respectively) configured to project laser beams into the transparent element portion 22. In one embodiment, the hologram generating portion 24 further comprises an LCD portion, wherein the LCD portion can include a reflective LCD portion or a transmissive LCD portion, as may be required for a particular electronic wavefront device application.

Wavefront rendering elements 12 and 14 are coupled to controller 32 and configured to produce a holographic wavefront on a respective plane of the wavefront rendering elements in response to a wavefront rendering signal or signals provided by the controller 32. More particularly, wavefront rendering elements 12 and 14 produce a holographic pattern and corresponding light wavefront on the respective plane of the wavefront rendering elements in response to the wavefront rendering signal or signals provided by controller 32. In addition, wavefront rendering element 14 includes a transparent element portion 42 and a hologram generating portion 44. In one embodiment, the transparent portion 42 comprises a form of holographic glass and wherein the hologram generating portion 44 comprises red, green, and blue lasers (46, 48, 50, respectively) configured to project laser beams into the transparent element portion 42.

Wavefront rendering elements 12 and 14 are coupled to controller 32 via suitable signal lines 34 and 36, respectively, which may include multiple signal lines housed within cabling 38. In addition, controller 32 may have an input for receiving further signal information, suitable for use in a given wavefront rendering application or applications, as indicated by reference numeral 40. Controller 32 is configured to provide overall control of the wavefront rendering according to the embodiments of the present disclosure, as discussed herein. In particular, controller 32 comprises any suitable computer and/or control unit that can be configured for performing the various functionalities as discussed with respect to the method of generating a wavefront according to the various embodiments herein. Furthermore, programming of the controller 32, for performing the methods according to the embodiments discussed herein, can be accomplished with use of suitable programming techniques.

FIG. 3 is a cross-sectional diagram view of an electronic wavefront rendering element 12 of the electronic wavefront device 10 according to an embodiment of the present disclosure. Wavefront rendering element 12 is coupled to controller 32 (FIG. 2) and configured to produce a holographic pattern and corresponding light wavefront on a respective plane 23 of the wavefront rendering element 12 in response to a corresponding wavefront rendering signal. The holographic wavefront pattern on the respective plane is configured to reproduce an incoming light wavefront that would otherwise be incident on the respective plane if an object or scene being reproduced from the incoming wavefront were actually in front of the at least one wavefront rendering device. In one embodiment, the holographic pattern and corresponding light wavefront comprises a image that corresponds to a virtual image 56 of the object or scene, that if the object or scene existed, would appear as if at a given distance 58 in front of the wavefront plane 23 of the respective wavefront rendering element 12, further in response to being viewed at a second distance 54, from an opposite side of the wavefront plane of the respective wavefront rendering element 12.

In FIG. 3, the wavefront rendering element 12 is shown as a side view of one of the two wavefront rendering elements or members that can be employed in a wearable display. On a hologram generating portion 24 of the wavefront rendering element 12 is disposed an electronically generated interferogram (hologram), wherein the interferogram is produced, for example, by a reflective LCD. The hologram is illuminated by three (3) different laser diodes (26, 28, 30) corresponding to the three (3) primary colors of red, green, and blue. The reflective LCD can be a color display or a monochrome display. In the latter case, color is achieved by sequentially showing the hologram for each primary color and synchronously switching on the corresponding laser diode.

The hologram shown has been calculated from an object (shown as virtual image 56) that is located at a distance 58 (for example, two (2) meters) in front of the wavefront rendering element 12. The wavefront rendering element 12 is configured to be positioned in close proximity to the eye 52 of an observer, as in a typical nose-worn glasses configuration. The lasers (26, 28, 30) illuminating the hologram reproduce the wavefront that belongs to the virtual image 56 and the observer sees an image 60 that appears to be two (2) meters in front of him, along a virtual optical path 62.

In one embodiment, controller 32 (FIG. 2) includes a video source and holographic calculation engine, for outputting a suitable wavefront generation signal. In addition, the electronic wavefront device 10 (FIG. 1) may also include earphones (not shown) proximate a location of the ears (not shown) to provide for an all-in one portable audio-video rendering device.

According to another embodiment of the present disclosure, the wearable device 10 is made to look similar to normal ophthalmic glasses or sunglasses. Furthermore, image reproduction takes place in the wavefront generating element (an image reproduction device) of the wearable device that has a similar approximate size, shape, place and look as a regular ophthalmic glass. Simply reproducing a real image (like one that would appear on a miniature TV screen) as close to the eye as regular ophthalmic glass will make it impossible for the eye to focus on the real image. Accordingly, the image reproduction device reproduces, with sufficient accuracy, an incoming wavefront that would be incident on the plane of the reproduction device, as if the object or scene to be reproduced would really have been in front of the viewer.

In one embodiment, controller 32 provides a wavefront generating signal for use in generating a corresponding wavefront, wherein the wavefront to be reproduced comprises a two-dimensional distribution of (scalar) light amplitude and phase on the plane of the image reproduction device. The distribution is spatially sampled in two dimensions according to well-known Nyquist criteria and represented by a matrix of discrete amplitude and phase pairs. The matrix representation lends itself to reproduction by a dot-matrix display device. Color reproduction requires reproducing the wavefront for three (3) different wavelengths of light. The three different wavelengths of light correspond to red, green, and blue, as is well-known in color-television technology.

In connection with generating a wavefront, a wavefront matrix is calculated from information available about the scene to be rendered, i.e., by using known transformations from optical theory. The transformations are based on the four well-known equations of Maxwell and applicable mathematics such as the Fourier transform. The calculation process includes a computer model of light ray propagation from the object (or scene) on its way to the eye, taking sample values at the intersection of the ray with the plane of the image reproduction device.

According to the embodiments of the present disclosure, information about the scene to be rendered may be available in a number of ways. These include, but are not limited to: (i) one or more 2-dimensional “screens” like TV-screens or computer-screens that are placed in 3-dimensional image space at a convenient viewing distance from, and at a suitable angle position towards, the observer; (ii) 3-dimentional computer graphic animations; or (iii) 3-dimensional television signal obtained by any suitable technique, including, but not limited to, stereoscopic cameras and real-time holography.

In one embodiment, the wavefront is reproduced by use of holographic techniques. In this embodiment, the calculated wavefront, as mentioned herein, will be further processed to generate a computer calculated interferogram (or hologram). The calculated interferogram is then used to control an SLM that is configured to reproduce the interferogram. Illumination of the SLM with a proper light source, for example, a laser beam, subsequently results in reproduction of the wavefront according to the principles of holography. Having reproduced the particular wavefront in front of the eye causes an observer to see an image of the original scene that was the start of the calculations.

It should be noted that a plurality of SLM implementations and holographic techniques exist, and may be developed in additional forms in the future. Accordingly, it should be noted that the embodiments of the present disclosure are not limited to a particular choice of the SLM implementations and holographic techniques discussed herein, although some will prove more beneficial than others in building a convenient image reproduction device with high image quality. Two examples include (i) an edge-lit technique that has the advantage of permitting a compact build-up with laser diodes mounted on the edge of the image reproduction device; and (ii) in some cases, white light can be used for hologram viewing rather than laser illumination, which could result in obvious size, cost and power savings.

It is also worth noting the difference between conventional computer calculated holography and the embodiments of the present disclosure. While the former art is primarily interested in reproducing 3D images, the embodiments of the present disclosure shape wavefronts close to the eye for reproducing any kind of image.

Further benefits arise from the case where a transmissive SLM is part of the image reproduction device, for instance in order to create an interferogram. By properly programming the SLM with a static pattern, which may be an interferogram, the following potential functionality is available: (i) sunglasses implemented via programmable light attenuation with the SLM; (ii) ophthalmic glass implemented via using a calculated interferogram in the SLM with adjustable strength; (iii) viewing the outside world simultaneously with the reproduced scene; and (iv) any combination of the above.

In another embodiment, the holographic wavefront further comprises a light regulating pattern and resulting wavefront configured to also shade light incident upon a first side of the at least one wavefront rendering element, from the first side to an opposite side of the at least one wavefront rendering element. In a further embodiment, the holographic wavefront comprises a pattern, wherein the pattern comprises one selected from the group consisting of a static adjustable holographic pattern, a dynamically computed hologram, information content of a computer screen, and a display of a 3D picture or a 3D video. In another embodiment, the at least one wavefront rendering element is further configured to simulate an ophthalmic lens element.

With respect to ophthalmic lens elements, the at least one wavefront rendering device comprises a first wavefront rendering element and a second wavefront rendering element. The first wavefront rendering element is responsive to first control signals for rendering a first wavefront, and the second wavefront rendering element is responsive to second control signals for rendering a second wavefront. In one embodiment, the first and second wavefronts correspond to optical shading wavefronts. In another embodiment, the first wavefront corresponds to a first ophthalmic prescription and the second wavefront corresponds to a second ophthalmic prescription. In addition, the first and second ophthalmic prescriptions comprise ophthalmic prescriptions for a pair of eyeglasses.

Additional benefits of the embodiments of the present disclosure can result from utilizing a fixed position of the image reproduction device with respect to the eye. This may result in relaxed requirements for the maximum viewing angle and hence relaxed requirements for the size of SLM pixels.

Furthermore, it is noted that holography is just one possible technique to reproduce wavefronts. The embodiments of the present disclosure could also make use of other technology as it becomes available. For instance, the viewing device could comprise a device that feeds a single coherent light beam through a matrix of cells where each cell can adjust amplitude and phase of the ray passing through it.

Simulations have been performed to verify the theoretical correctness of the concept. While these simulations were not designed to completely model the above embodiments, the simulation results provide proof of concept for the idea of reproducing a wavefront close to the eye by means of a hologram. The simulations included various calculations. FIG. 4 is a simulated pictorial view of an image of an object located at a predetermined distance in front of the plane of a wavefront rendering element of the electronic wavefront device according to an embodiment of the present disclosure. In particular, simulated is a 1×1 cm 2D object in a 1024×1024 grid, illuminated by a laser with a wavelength of 1 μm. FIG. 5 is a simulated pictorial view of an image of the object of FIG. 4 located at a second distance behind the plane of the wavefront rendering element of the electronic wavefront device. In particular, the object is at a distance of two (2) meters in front of an eye which is modeled as a perfect lens with focal length of 22 mm. A sharp image of the object is expected at 22.244692 mm behind the eye lens plane. FIG. 5 is enlarged to compensate for the eye lens magnification of approximately 1/100.

Subsequently, a holographic recording is simulated in the plane of the eye lens itself (i.e. distance between hologram and eye is zero). The hologram is obtained by mixing the wavefront from the object with a reference beam from the same laser under an angle of 0.6 mradials in x and y direction. FIG. 6 shows the resulting hologram. FIG. 6 is thus a simulated view of a resulting hologram of the image of the object of FIG. 4 located at a plane of the eye lens of an observer, wherein the distance between the hologram and the eye is zero. Next, reproduction is simulated by using this amplitude hologram and illuminating it again with the reference beam. The result is observed 22.244692 mm behind the eye lens plane in order to simulate what the observer would see. FIG. 7 is thus a simulated view of a hologram of the image of the object of FIG. 4 as observed at a second distance behind the plane of the wavefront rendering element of the electronic wavefront device. Although the simulated result shows a number of artefacts, the object is reproduced sharply. The removal of the artefacts can be expected from optimization of the chosen implementation. Note that the “pixel” size in this simulation is around 10 μm.

It is noted that applications for implementation of the electronic wavefront device according to the embodiments of the present disclosure may include one or more of the following. In the context of mobile entertainment, the electronic wavefront device of the present disclosure can be implemented in the form of electronic wavefront eyeglasses, wherein the eyeglasses can be viewed as the ultimate lifestyle device for active people. For example, time spent working out can also be used to watch PodCasts, movies, soaps, etc. In the context of mobile communication, the electronic wavefront device of the present disclosure can be implemented as a peripheral to a mobile phone for video phone and watching pictures, movies and tv-on-mobile from the mobile phone. In the context of medical applications, the electronic wavefront device of the present disclosure can be implemented as adjustable ophthalmic glasses, for example, automatic reading glasses. Various other uses for unusual eye corrections and image magnification may also be possible. In the context of professional applications, the electronic wavefront device of the present disclosure may be implemented to provide a heads-up display for situations where there is no reflecting surface available in front of the observer, having a wide range of possible applications including industrial and military. Furthermore, in another context, the electronic wavefront device of the present disclosure may be implemented in a suitable manner to enhance displays in mobile telephone and mobile entertainment devices. For example, with the embodiments of the present disclosure, it might be possible to produce a wider, deeper and 3D image from the tiny mobile display.

Furthermore, according to one embodiment, an electronic wavefront device comprises a controller configured to provide a wavefront rendering signal, two wavefront rendering elements, and a frame. The two wavefront rendering elements coupled to the controller and are configured to produce a holographic wavefront on a respective plane of the wavefront rendering elements in response to the wavefront rendering signal. The holographic wavefront on the respective plane is configured to reproduce an incoming wavefront that would otherwise be incident on the respective plane if an object or scene being reproduced from the incoming wavefront were actually in front of the respective wavefront rendering element. The holographic wavefront further comprises an image that corresponds to a virtual image of the object or scene, that if the object or scene existed, would appear as if at a given distance in front of the wavefront plane of the respective wavefront rendering element, further in response to being viewed at a second distance, from an opposite side of the wavefront plane of the respective wavefront rendering element. The two wavefront rendering elements are coupled to the frame in a manner adapted to position the wavefront plane of each of the two wavefront rendering elements at the second distance in front of an observer's eyes. In one embodiment, each wavefront rendering element includes a transparent element portion and a hologram generating portion, further wherein the transparent portion comprises holographic glass and wherein the hologram generating portion comprises red, green, and blue lasers configured to project laser beams into the transparent element portion.

Moreover, according to another embodiment, a method of electronically rendering a wavefront comprises configuring a controller to provide a wavefront rendering signal and configuring at least one wavefront rendering device to produce a holographic wavefront on a respective plane of the at least one wavefront rendering device in response to the wavefront rendering signal. The holographic wavefront on the respective plane reproduces an incoming wavefront that would otherwise be incident on the respective plane if an object or scene being reproduced from the incoming wavefront were actually in front of the at least one wavefront rendering device. Configuring the at least one wavefront rendering device to produce a holographic wavefront comprises producing an image that corresponds to a virtual image of the object or scene, that if the object or scene existed, would appear as if at a given distance in front of the wavefront plane of the respective wavefront rendering device, further in response to being viewed at a second distance, from an opposite side of the wavefront plane of the respective wavefront rendering device. In a further embodiment, configuring the at least one wavefront rendering device comprises configuring two wavefront rendering elements, and the method further comprises coupling the two wavefront rendering elements to a frame in a manner adapted to position the wavefront plane of each of the two wavefront rendering elements at the second distance in front of an observer's eyes in response to the frame being worn by the observer.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. An electronic wavefront device comprising:
a controller configured to provide a wavefront rendering signal; and
at least one wavefront rendering device coupled to said controller and configured to produce a holographic wavefront on a respective plane of the at least one wavefront rendering device in response to the wavefront rendering signal, wherein the holographic wavefront on the respective plane is configured to reproduce an incoming wavefront that would otherwise be incident on the respective plane if an object or scene being reproduced from the incoming wavefront were actually in front of the at least one wavefront rendering element.

2. The device of claim 1, wherein the holographic wavefront comprises an image that corresponds to a virtual image of the object or scene, that if the object or scene existed, would appear as if at a given distance in front of the wavefront plane of the respective wavefront rendering device, further in response to being viewed at a second distance, from an opposite side of the wavefront plane of the respective wavefront rendering device.

3. The device of claim 2, wherein the at least one wavefront rendering device comprises two wavefront rendering elements, the wavefront device further comprising:
a frame, wherein the two wavefront rendering elements are coupled to the frame in a manner adapted to position the wavefront plane of each of the two wavefront rendering elements at the second distance in front of an observer's eyes.

4. The device of claim 3, wherein the frame comprises one selected from the group consisting of a hand-held non-wearable frame, a wearable frame, an eyeglass frame, and a helmet.

5. The device of claim 1, further comprising:
a wearable eyeglass frame, wherein the at least one wavefront rendering device comprises two wavefront rendering elements coupled to the eyeglass frame and adapted to be positioned in front of a wearer's eyes.

6. The device of claim 1, wherein the holographic wavefront further comprises a light regulating pattern and corresponding wavefront configured to also shade light incident upon a first side of the at least one wavefront rendering device, from the first side to an opposite side of the at least one wavefront rendering device.

7. The device of claim 1, wherein the holographic wavefront comprises a pattern.

8. The device of claim 7, wherein the pattern comprises one selected from the group consisting of a static adjustable holographic pattern, a dynamically computed hologram, information content of a computer screen, and a display of a 3D picture or a 3D video.

9. The device of claim 1, wherein the at least one wavefront rendering device is further configured to simulate an ophthalmic lens element.

10. The device of claim 1, wherein the at least one wavefront rendering device comprises two wavefront rendering elements, the device further comprising:
an eyeglass frame, wherein the two wavefront rendering elements are embodied within the eyeglass frame.

11. The device of claim 1, wherein each wavefront rendering device includes a transparent element portion and a hologram generating portion.

12. The device of claim 11, further wherein the transparent portion comprises holographic glass.

13. The device of claim 11, wherein the hologram generating portion comprises red, green, and blue lasers configured to project laser beams into the transparent element portion.

14. The device of claim 13, wherein the hologram generating portion further comprises an LCD portion.

15. The device of claim 14, further wherein the LCD portion includes a reflective LCD portion.

16. The device of claim 14, further wherein the LCD portion includes a transmissive LCD portion.

17. The device of claim 1, wherein the at least one wavefront rendering device comprises a first wavefront rendering element and a second wavefront rendering element, wherein the first wavefront rendering element is responsive to first control signals for rendering a first wavefront, and wherein the second wavefront rendering element is responsive to second control signals for rendering a second wavefront.

18. The device of claim 17, wherein the first and second wavefronts correspond to optical shading wavefronts.

19. The device of claim 17, wherein the first wavefront corresponds to a first ophthalmic prescription and the second wavefront corresponds to a second ophthalmic prescription.

20. The device of claim 19, wherein the first and second ophthalmic prescriptions comprise ophthalmic prescriptions for a pair of eyeglasses.

21. An electronic wavefront device comprising:
a controller configured to provide a wavefront rendering signal;
two wavefront rendering elements coupled to said controller and configured to produce a holographic wavefront on a respective plane of the wavefront rendering elements in response to the wavefront rendering signal, wherein the holographic wavefront on the respective plane is configured to reproduce an incoming wavefront that would otherwise be incident on the respective plane if an object or scene being reproduced from the incoming wavefront were actually in front of the respective wavefront rendering element, wherein the holographic wavefront further comprises an image that corresponds to a virtual image of the object or scene, that if the object or scene existed, would appear as if at a given distance in front of the wavefront plane of the respective wavefront rendering element, further in response to being viewed at a second distance, from an opposite side of the wavefront plane of the respective wavefront rendering element; and
a frame, wherein the two wavefront rendering elements are coupled to the frame in a manner adapted to position the wavefront plane of each of the two wavefront rendering elements at the second distance in front of an observer's eyes.

22. The device of claim 21, wherein each wavefront rendering element includes a transparent element portion and a hologram generating portion, further wherein the transparent portion comprises holographic glass and wherein the hologram generating portion comprises red, green, and blue lasers configured to project laser beams into the transparent element portion.

23. A method of electronically rendering a wavefront comprising:
configuring a controller to provide a wavefront rendering signal; and
configuring at least one wavefront rendering device to produce a wavefront on a respective plane of the at least one wavefront rendering device in response to the wavefront rendering signal, wherein the wavefront on the respective plane reproduces an incoming wavefront that would otherwise be incident on the respective plane if an object or scene being reproduced from the incoming wavefront were actually in front of the at least one wavefront rendering element.

24. The method of claim 23, wherein configuring the at least one wavefront rendering device to produce a wavefront comprises producing an image that corresponds to a virtual image of the object or scene, that if the object or scene existed, would appear as if at a given distance in front of the wavefront plane of the respective wavefront rendering device, further in response to being viewed at a second distance, from an opposite side of the wavefront plane of the respective wavefront rendering device.

25. The method of claim 24, further wherein configuring the at least one wavefront rendering device comprises configuring two wavefront rendering elements, the method further comprising:
coupling the two wavefront rendering elements to a frame in a manner adapted to position the wavefront plane of each of the two wavefront rendering elements at the second distance in front of an observer's eyes in response to the frame being worn by the observer.
